(19) United States
(12) Patent Application Publication
(10) Pub. No.: US 2012/0292987 A1
(43) Pub. Date: Nov. 22, 2012

(54) System and Method Providing Power Within a Battery Pack

(75) Inventors: Brian D. Rutkowski, Ypsilanti, MI (US); Brian C. Moorhead, Willis, MI (US); Paul W. Firehammer, Saline, MI (US); John W. Wagner, Ann Arbor, MI (US)

(73) Assignee: A123 SYSTEMS, INC., Waltham, MA (US)

(21) Appl. No.: 13/575,257

(22) PCT Filed: Jan. 26, 2011
(86) PCT No.: PCT/US2011/022626

§ 371 Date: Jul. 25, 2012

Related U.S. Application Data
(60) Provisional application No. 61/298,654, filed on Jan. 27, 2010.

(51) Int. Cl. B60L 1/00

(52) U.S. Cl. 307/9.1

(57) ABSTRACT

A system for supplying power internal to a battery pack is disclosed. In one embodiment, the system includes a power supply that is powered by battery cells in the battery pack such that each battery cell supplies substantially the same amount of current to power the power supply. In this way, power can be distributed within the battery pack without causing imbalance between an amount of charge stored in different battery cells.

### TECHNICAL FIELD

The present application relates to providing power within a battery pack which includes a plurality of battery cells.

### BACKGROUND AND SUMMARY

Battery packs may be a source of power for mobile applications. For example, a battery pack may be used to power a vehicle. However, different mobile application may have different power and packaging requirements. For example, a high voltage power source having a lower amp-hour rating may be desirable for a very small vehicle whereas a high voltage power source having a higher amp-hour rating may be desirable for a larger vehicle. Assuming the same power density between power sources, it can be understood that a larger battery with additional cells may be required to meet the requirements of the larger vehicle. Thus, it may be understood that many different battery pack configurations may be required for many different applications.

One obstacle in providing a wide range of battery packs to suit the possible number of applications is the cost of designing new battery pack electronics to meet the requirements of each application. In particular, it may not be cost effective to redesign the power distribution system within a battery pack each time a new application requires new battery pack requirements. Further, it may be challenging to provide power within the battery pack in a way that does not disturb the balance between battery cells within the battery pack. For example, it may be undesirable to provide power within a battery pack when the power source causes voltage differences between battery pack battery cells.

The inventors herein have developed a system for controlling power distribution within a battery pack. Specifically, in one example, a system for controlling power distribution within a battery pack supplying power to a vehicle is disclosed. The system comprises high voltage circuitry within said battery pack, said high voltage circuitry isolated from low voltage circuitry within said battery pack; a plurality of battery cells within said battery pack; and a power supply coupled to the negative side of said high voltage circuitry, said power supply coupled to said plurality of battery cells such that said power supply loads each of said plurality of battery cells substantially equally.

By coupling an internal power supply to the negative side of the high voltage output of a battery in such a way that the battery cells are substantially equally loaded, power may be provided for circuitry within the battery pack in a way that maintains voltage balance between battery cells within the battery pack. In this way, a power supply can be configured to supply power within the battery pack without having to discharge battery cells to a passive resistor to maintain a voltage level between battery cells. In addition, a wide range power supply may be selected such that a single power supply design may be used for a range of battery applications. Thus, it may be possible to reduce the number of power supply designs for a range of applications when the power supply is configured in this way.

The present description may provide several advantages. In particular, the approach may provide a scalable solution for providing power within a battery pack. Further, the approach may reduce design costs. Further still, the approach may provide a robust power solution for systems that have electronic modules associated with each battery cell stack within a battery pack.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic view of an electrical system for a battery pack;

FIG. 2 shows a schematic view of power supply connections within a battery pack;

FIG. 3 shows another schematic view of power supply connections within a battery pack;

FIG. 4 shows a schematic view of an example use of a battery pack; and

FIG. 5 shows a flow chart illustrating a method for distributing power within a battery pack supplying power to propel a vehicle.

### DETAILED DESCRIPTION OF THE DEPICTED EMBODIMENTS

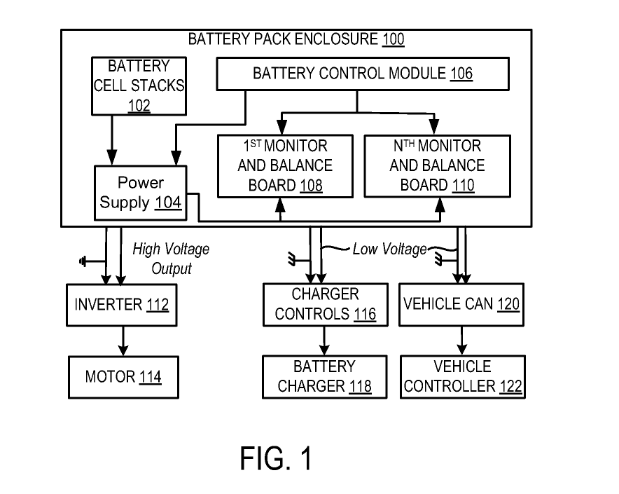

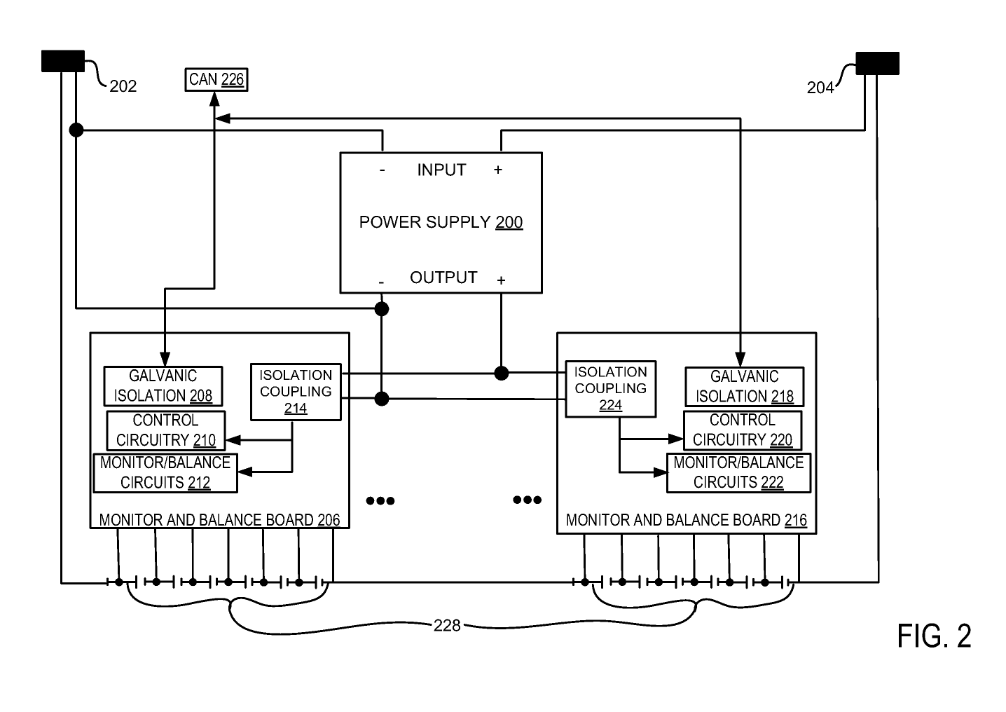

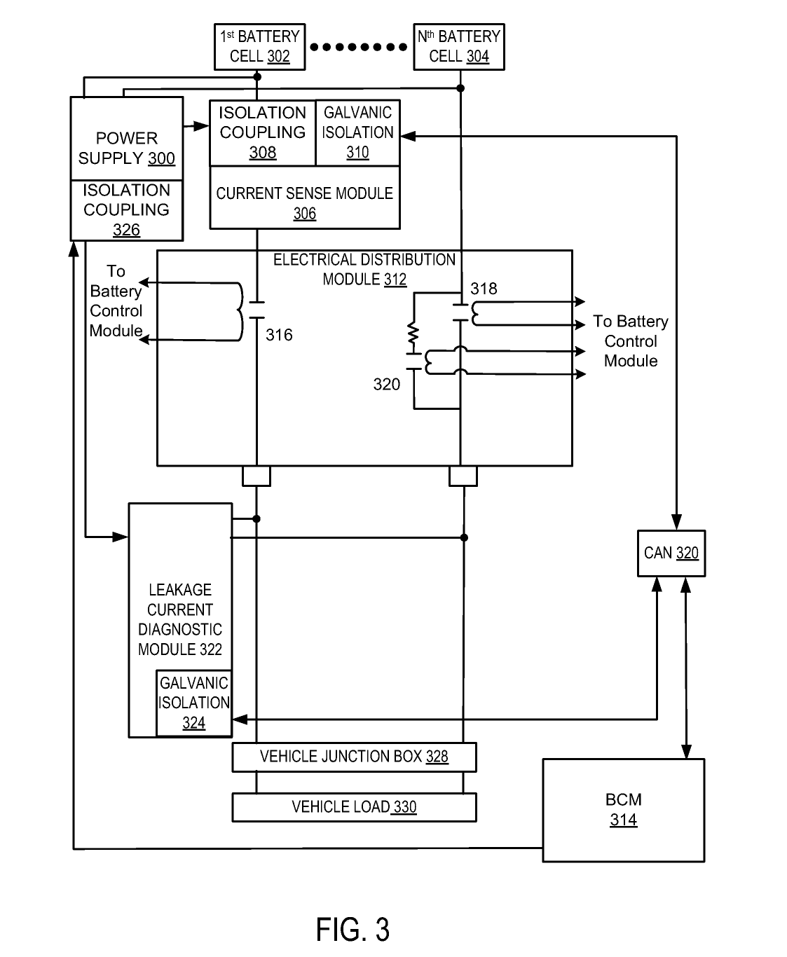

The present description is related to providing power within a battery pack. In one embodiment, a power supply is included in a system of distributed boards that allow scalable design of a battery pack. The power supply may be integrated into a battery pack and vehicle system as is illustrated in FIG. 1. The power supply may be configured to draw substantially equal current from battery cells located in the battery pack. In one embodiment, the power supply may be coupled to the battery cells as is illustrated in FIG. 2. Further, the power supply may provide power to diagnostic monitoring boards that are on the load side of a battery output contactor as is illustrated in FIG. 3.

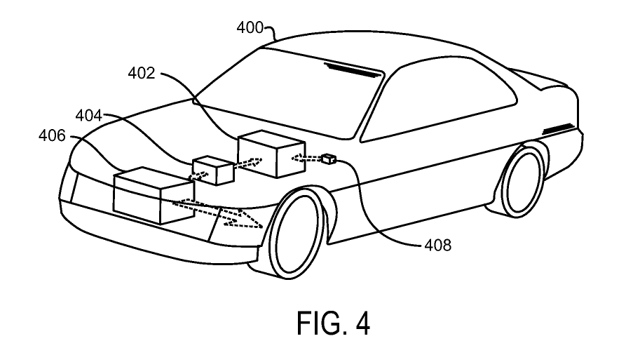

FIG. 1 shows a schematic diagram of a battery pack enclosure 100 which may be included in a vehicle such as battery pack 402 in FIG. 4. Battery pack enclosure 100 includes one more battery cell stacks 102 which may each be comprised of a plurality of battery cells. Further, battery pack enclosure 100 includes battery control module (BCM) 106. The BCM is a low voltage central controller which may be used to coordinate battery management functions, such as communications with systems external to the battery pack (e.g., a vehicle controller), management of other modules that are integrated into the battery pack (e.g., electrical distribution module (EDM) and monitor and balance boards (MBB), etc.), battery pack charging and discharging, battery enclosure humidity control, managing battery control modes (e.g., sleep and operate), and sensor signal conditioning and processing. Thus, the BCM is a main controller board for commanding a scalable number of slave controller boards. Further, the BCM may be comprised of a microprocessor having random access memory, read only memory, input ports, real time clock, and output ports.

As shown in FIG. 1, the BCM 106 manages a plurality of monitor and balance boards (MBB) from a first MBB 108 to an n^{th} MBB 110. For example, each battery cell stack may be coupled to an MBB; thus, there may be n MBBs for n battery cell stacks. The MBB is further described in detail below with reference to FIG. 2.

The BCM 106 is shown in communication via high voltage circuitry with inverter 112 in FIG. 1. Inverter 112 may be used to convert DC current supplied by the battery pack to AC current for the motor 114, for example. In some embodiments, the inverter may convert AC current from the motor to DC current in order to charge one or more of the battery cells.

Further, the BCM 106 is shown in communication via low voltage circuitry with battery charger controls 116 for controlling the battery charger 118. The BCM 106 is also in communication via low voltage circuitry with a vehicle controller area network (CAN) 120 for communicating with a vehicle controller 122. Further, BCM 106 may communicate to modules within the battery pack over a second CAN, the second CAN local to battery pack 100.

Power supply 104 is shown in communication with battery cell stacks 102. Battery cell stacks 102 provide input power to power supply 104. Power supply 104 may be connected in parallel with all battery cells within the battery pack so that all battery cells are equally loaded by power supply 104. Power supply 104 may output a DC voltage to one or more boards distributed throughout battery pack 100. Power supply 104 may provide power to at least a portion of monitor and balance boards 108 and 110.

Turning to FIG. 2, schematic view of power supply connections within a battery pack is shown. Power supply 200 receives power from negative high voltage terminal 202 and from positive high voltage terminal 204. By connecting power supply 200 in parallel with all battery cells in the battery enclosure, battery cells may be equally loaded by the power supply so that one cell does not discharge at a different rate than another battery cell as a result of power supply 200. In another embodiment, power supply 200 may be connected to a group of battery cells, the group of battery cells less than all the battery cells. The power supply may be connected to less than all battery cells in one embodiment where two or more groups of battery cells may provide separate output from the battery pack. For example, if a battery pack is configured to supply power outside the battery pack by a first group of battery cells until the first group of battery cells is discharged to a threshold level, and then the battery pack supplies power outside the battery pack by a second group of battery cells. In such a configuration, power supply 200 may be connected to a single group of battery cells. Further, the input of power supply 200 may be switched between the first group of battery cells and the second group of battery cells based on the amount of charge stored in the first or second group of battery cells.

The battery pack includes mixed voltage (e.g., includes high voltage and low voltage circuitry) circuitry. Low voltage circuitry may include circuitry that is powered by less than 20 volts, for example. High voltage circuitry may handle voltage that depends on the application. For example, one application may call for circuitry that operates with 400 volts. High voltage circuitry is isolated from low voltage circuitry. For example, there may be no electrically conductive paths between the high voltage circuitry and the low voltage circuitry, excepting leakage current monitor circuitry. Where low voltage circuitry is used to control high voltage circuitry, isolation may be achieved by magnetic or optical coupling. For example, the low voltage CAN link may be magnetically coupled to the high voltage circuitry through a circuit that transfers signals between the low voltage circuitry and that high voltage circuitry by way of a transformer. Other signals may be optically coupled by a light emitter and a light detector such that signals are transferred by light.

Monitor and balance boards (MBB) 206 and 216 are boards that may be managed by BCM 106 of FIG. 1, for example. As discussed above and indicated by the series of dots in FIG. 2, a battery pack may include a plurality of battery cell stacks and a plurality of MBB boards. Voltage of battery cells 228 in the battery cell stacks is monitored and balanced by MBB 206 and 216, which may include a plurality of current, voltage, and other sensors. Battery cells stacks may be comprised of different numbers of battery cells and the battery cells within a battery cell stack may be connected in parallel or series to provide the a range of battery output voltages and amp-hour current capacity.

In FIG. 2, the MBB is configured such that control circuitry (e.g., microprocessor and memory) 210 and 220 is included in the high voltage circuitry of the battery pack. Further, battery cell monitoring and voltage balancing circuitry 212 and 222 is also included in the high voltage circuitry of the battery pack. CAN link 226 provides a communication link between the MBB and the BCM. The CAN is magnetically isolated by a coupling transformer and coding/decoding circuitry 208 and 218 on MBB 206 and MBB 216. Monitor and voltage balance circuitry 212 and 222 may include one or more A/D convertors, one or more transistors for switching one or more load resistors across battery cells. Further, one or more comparators may be used to determine when to discharge battery cells that exceed a threshold voltage. In one embodiment, the output of a comparator circuit may indicate when it is desirable to discharge a particular battery cell. For example, a comparator may be referenced to a threshold voltage if the threshold voltage is exceeded by the voltage across a battery cell, the comparator changes state to indicate it may be desirable to discharge the individual cell or cells that may be connected in parallel.

Power supply 200 may supply power to the MBB and associated circuitry by way of isolation coupler 214. In one embodiment, isolation coupler 214 may be a DC/DC converter where the input of the DC/DC converter is not electrically coupled to the output of the DC/DC converter. The output of the DC/DC converter may be referenced to a potential on the MBB. For example, when circuitry on the MBB is in communication with one or more battery cells the output of the DC/DC converter may be referenced to the battery cell voltage.

Referring to FIG. 3, another schematic view of power supply connections within a battery pack is shown. FIG. 3 shows two battery cells 302 and 304 of a plurality of battery cells indicated by the dots between the battery cells. Battery cells 302 and 304 are coupled to the high voltage bus. Power supply 300 is coupled to the negative terminal of the high voltage bus as is described in the description of FIG. 2.

In FIG. 3, power supply 300 is shown in communication with a current sense module (CSM) 306 and a leakage current diagnostic module (IDM) 322. Power supply 300 may supply power to the CSM 306 by way of isolation coupler 308. Further, power supply 300 may supply power to IDM 322 by way of isolation coupler 326. In one embodiment, isolation couplers 308 and 326 may be a DC/DC converter where the input of the DC/DC converter is not electrically coupled to the output of the DC/DC converter. The output of the DC/DC converter may be referenced to a potential on the respective CSM and IDM. Power supply 300 may be activated by BCM 332 by way of isolation coupling 326.

CSM 306 is in communication with BCM 332 by way of CAN 320. CAN 320 is part of the battery pack low voltage circuitry. CAN 320 is isolated from high voltage circuitry as described above. CSM includes a current sensing that may be in the form of a shunt resistor. Circuitry partitioned on the high voltage side of galvanic isolation 310 may include a microprocessor for sending and receiving CAN messages and an A/D converter for converting sensed current into digital data.

Electrical distribution module 312 (EDM) controls power flow from the battery pack to external loads. EDM 312 is in communication with BCM 332 via CAN 320. Further, BCM 332 provides low voltage outputs to actuate magnetically actuated contactors 314, 316, and 318. BCM 332 is magnetically isolated from the high voltage bus by way of magnetically actuated contactors 314, 316, and 318.

IDM 322 monitors leakage current between the high voltage bus and the low voltage bus. In one embodiment, leakage current may be monitored by switching in a series of resistors between the high voltage bus and the low voltage bus. Leakage current may be monitored by measuring voltage that may develop across one load resistor when the load resistors are switched in between the low voltage bus and the high voltage bus. IDM 322 is isolated from the low voltage bus by way of galvanic isolation 324. Galvanic isolation of CAN is as described above.

Vehicle junction box 328 receives power from battery pack and distributes power to vehicle load 330. The vehicle load may include an inverter and vehicle drive motor.

Referring now to FIG. 4, a schematic diagram of a vehicle 400 including a battery pack 402 is shown. In the example of FIG. 4, battery pack 402 is comprised of one or more battery cell stacks which may each include a plurality of battery cells. As shown, battery pack 402 is in communication with inverter 404 which is in communication with motor 406 of the vehicle 400 via high voltage circuitry. The negative side of the battery pack may be the reference for the high voltage circuitry. Further, battery pack 402 is in communication with a vehicle controller 408 via low voltage circuitry where a vehicle chassis may be a ground reference for the low voltage circuitry. The high voltage circuitry may be isolated from the low voltage circuitry via galvanic isolation. In particular, there may be no electrical connections between the high voltage bus and the low voltage bus. Galvanic isolation may be provided by magnetic or optical coupling when data and signals are exchanged between high and low voltage systems.

Thus, the system shown in FIGS. 1-4 provides for a system for controlling power distribution within a battery pack supplying power to a vehicle, comprising: high voltage circuitry within the battery pack, the high voltage circuitry isolated from low voltage circuitry within the battery pack; a plurality of battery cells within the battery pack; and

a power supply coupled to the negative side of the high voltage circuitry, and the power supply coupled to the plurality of battery cells such that the power supply loads each of the plurality of battery cells substantially equally. In this way, the battery cells of the battery pack can be loaded to reduce the possibility of battery cell imbalance. The system also includes where the power supply is coupled to at least one battery cell stack battery cell balancing board. The system includes where the power supply is coupled to at least one module that senses the current output of the battery pack. The system also includes where an output of the power supply is isolated from individual cells that are included in the at least one battery cell stack. In one example, the system includes where the power supply includes an input for activating the power supply, the input activated by the low voltage circuitry, and where there is galvanic isolation between the power supply and the low voltage circuitry. The system includes where the power supply accepts a range of input voltage to produce an output voltage. Thus, the power supply can maintain an output even when input to the power supply change, at least during some conditions. The system includes where the power supply has a DC output. The system also includes where the plurality of battery cells are comprised of lithium-ion battery cells.

The system shown in FIGS. 1-4 also provides for a system for controlling power distribution within a battery pack supplying power to a vehicle, comprising: high voltage circuitry within said battery pack; low voltage circuitry within said battery pack; a plurality of battery cells within said battery pack; galvanic isolation between said low voltage circuitry and said high voltage circuitry; and a power supply coupled to the negative side of said high voltage circuitry and coupled to a plurality of battery cells, said power supply in isolated communication with circuitry of one or more boards coupled to one or more battery cell stacks within said battery pack. In this way, power from all battery cells may be combined to power electronics and controls within the battery pack. The system includes where the power supply is in isolated communication with the circuitry by one or more DC/DC converters. The system also includes where the power supply is switchable coupled to the one or more boards. The system includes where the power supply is powered by one or more groups of battery cells within the battery pack. The system also includes where the power supply is activated by a galvanic isolated input.

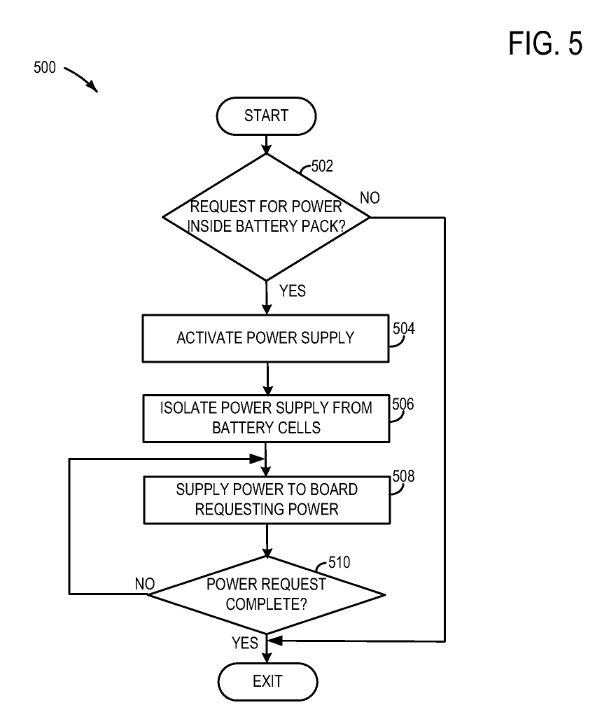

Finally, FIG. 5 shows a flow chart illustrating a method 500 for distributing power within a battery pack supplying power to propel a vehicle. Specifically, method 500 may provide power to electronic modules of a battery pack including the components and systems described in FIG. 1-4.

At step 502 of method 500, it is judged whether or not there is a request for power supplied by a power supply in the battery pack. The power supply request may come from the BCM to the power supply by way of low voltage circuitry. In one example, the request may be initiated by a digital output of a microprocessor within the BCM. The microprocessor output may be optically isolated from the high voltage circuitry in the power supply. If power is requested from the power supply, method 500 proceeds to 504. Otherwise, method 500 exits.

At 504, method 500 activates the power supply. The power supply may be activated by closing a switch that couples the power supply to battery cells in the battery pack. As described above, the power supply may be coupled to battery cells so that the power supply draws substantially the same amount of current from each battery cell in the battery pack. In another example, the power supply may be switched between two or more groups of battery cells as described above. Further, the power supply may be coupled to the negative terminal of the high voltage bus. After the power supply is activated method 500 moves to 506.

At 506, method 500 isolates power from the power supply from battery cells. In one embodiment, method 500 isolates power from the power supply via a DC/DC converter. It should be noted that the output of the DC/DC converter may be referenced to a potential on a board powered by the power supply. Further, the potential may be that of one side of a battery cell.

At 508, method 500 supplies power from the power supply to components or circuitry on a board within the battery pack. Power may be supplied to the board by way of DC/DC converter described at 506. It should be noted that the output of the power supply may be switched to power specific board in the battery pack by way of signals from the BCM. In one example, the BCM may activate and deactivate transistors, such as FETs to control the distribution of power from the power supply to specific modules within the battery pack. In one example, a board may request power in response to a condition of a battery cell. For example, if a cell voltage is higher or lower than a desired voltage, an output of a MBB may request power so that a microprocessor may activate and then store information relating to the state of the battery cell. The BCM can then activate the appropriate transistor so that power is routed from the power supply to the MBB requesting power.

At 510, method 500 determines if the power request is complete. In one example, the power request is complete when the power supply input transitions from a high state to a low state. In one embodiment, the power supply may delay turning off for a predetermined amount of time so that any processes may be completed. For example, if a microprocessor is storing data regarding the status of a battery cell that was at a higher or lower voltage than desired, the power supply may remain on even if the battery cell voltage later matches the desired voltage. In particular, the power supply may remain active for a predetermined amount of time so that the microprocessor may complete the process of storing data. If the power request is complete method 500 exits. Otherwise, method 500 returns to 508.

In this way, the method of FIG. 5 provides for a method for distributing power within a battery pack supplying power to propel a vehicle, comprising: providing input power to a power supply within the battery pack, said input power provided by battery cells of the battery pack; electrically coupling the power supply to the negative side of a high voltage output of a battery pack; and isolating an output of the power supply from the battery cells and supplying power to at least an electrical device within said battery pack. Thus, power distribution within the battery pack can be isolated. The method further comprises activating the power supply by low voltage circuitry within the battery pack, the low voltage circuitry isolated from the power supply and high voltage circuitry within the battery pack. The method includes where the isolation is galvanic isolation. The method includes where the power supply is powered by all battery cells of the battery pack. In this way, all battery cells of the battery cell stack may be discharged substantially equally. The method includes where the battery cells are lithium-ion battery cells. In another example, the method includes where the at least an electrical device within the battery pack is a battery cell balancing circuit board. The method also includes where the low voltage circuitry activates said power supply in response to a condition of a battery cell stack.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for controlling power distribution within a battery pack supplying power to a vehicle, comprising:
high voltage circuitry within said battery pack, said high voltage circuitry isolated from low voltage circuitry within said battery pack;
a plurality of battery cells within said battery pack; and
a power supply coupled to the negative side of said high voltage circuitry, and the power supply coupled to said plurality of battery cells such that said power supply loads each of said plurality of battery cells substantially equally.

2. The system of claim 1, wherein said power supply is coupled to at least one battery cell stack battery cell balancing board.

3. The system of claim 1, wherein said power supply is coupled to at least one module that senses the current output of said battery pack.

4. The system of claim 2, wherein an output of said power supply is isolated from individual cells that are included in said at least one battery cell stack.

5. The system of claim 1, wherein said power supply includes an input for activating said power supply, said input activated by said low voltage circuitry, and where there is galvanic isolation between said power supply and said low voltage circuitry.

6. The system of claim 1, wherein said power supply accepts a range of input voltage to produce an output voltage.

7. The system of claim 1, wherein said power supply had a DC output.

8. The system of claim 1, wherein said plurality of battery cells are comprised of lithium-ion battery cells.

9. A system for controlling power distribution within a battery pack supplying power to a vehicle, comprising:
high voltage circuitry within said battery pack;
low voltage circuitry within said battery pack;
a plurality of battery cells within said battery pack;
galvanic isolation between said low voltage circuitry and said high voltage circuitry; and
a power supply coupled to the negative side of said high voltage circuitry and coupled to a plurality of battery cells, said power supply in isolated communication with circuitry of one or more boards coupled to one or more battery cell stacks within said battery pack.

10. The system of claim 9, wherein said power supply is in isolated communication with said circuitry by one or more DC/DC converters.

11. The system of claim 9, wherein said power supply is switchable coupled to said one or more boards.

12. The system of claim 9, wherein said power supply is powered by one or more groups of battery cells within said battery pack.

13. The system of claim 9, wherein said power supply is activated by a galvanic isolated input.

14. A method for distributing power within a battery pack supplying power to propel a vehicle, comprising:
providing input power to a power supply within said battery pack, said input power provided by battery cells of said battery pack;
coupling said power supply to the negative side of a high voltage output of a battery pack; and
isolating an output of said power supply from said battery cells and supplying power to at least an electrical device within said battery pack.

15. The method of claim 14, further comprising activating said power supply by low voltage circuitry within said battery pack, said low voltage circuitry isolated from said power supply and high voltage circuitry within said battery pack.

16. The method of claim 15, wherein said isolation is galvanic isolation.

17. The method of claim 14, wherein said power supply is powered by all battery cells of said battery pack.

18. The method of claim 14, wherein said battery cells are lithium-ion battery cells.

19. The method of claim 14, wherein said at least an electrical device within said battery pack is a battery cell balancing circuit board.

20. The method of claim 15, wherein said low voltage circuitry activates said power supply in response to a condition of a battery cell stack.
